(19) United States
(12) Patent Application Publication
(10) Pub. No.: US 2017/0350865 A1
(43) Pub. Date: Dec. 7, 2017

(54) Flow Measuring Device

(71) Applicant: Endress + Hauser Flowtec AG, Reinach (CH)

(72) Inventors: Timo Kretzler, Binzen (DE); Daniel Kollmer, Maulburg (DE)

(21) Appl. No.: 15/537,913

(22) PCT Filed: Nov. 18, 2015
(86) PCT No.: PCT/EP2015/076924

§ 371 Date: Jun. 20, 2017

(30) Foreign Application Priority Data
Dec. 23, 2014 (DE) 102014119512.4

(51) Int. Cl. G01N 29/036; G01N 29/22; G01F 1/58; G01F 1/60

(52) U.S. Cl. CPC G01N 29/036; G01F 1/60; G01N 29/222; G01F 1/588; G01N 2291/022; G01N 2291/02836; G01N 2291/021

(57) ABSTRACT

A magneto-inductive flow measuring device (1) comprising a measuring tube (2) on which a magnet system and two or more measuring electrodes (3) are arranged and/or secured, wherein the measuring tube (2) has in- and outlet regions (11, 12) with a first cross section and wherein the measuring tube (2) has between the in- and outlet regions (11, 12) a middle segment (10), which has a second cross section, wherein the measuring electrodes (3) are arranged in the middle segment (10) of the measuring tube (2), wherein the middle segment (10) at least in the region of the measuring electrodes (3) is surrounded by a tube holder (15), which guards against cross-sectional deformation of the second cross section.

The present invention relates to a flow measuring device.

Flow measuring devices are differentiated using different criteria. The most widely used differentiating criterion is that differentiating according to measuring principle. Correspondingly, known are e.g. Coriolis flow measuring devices, ultrasonic, flow measuring devices, thermal, flow measuring devices, vortex, flow measuring devices, magneto-inductive flow measuring devices, SAW (surface acoustic wave) flow measuring devices, V-cone flow measuring devices and suspended body flow measuring devices. Corresponding flow measuring devices are commercially available from the applicant or others.

DE 10 2007 007 812 A1 describes a sensor, which delivers information concerning the quality of the measured medium. A volume flow rate is not detected.

For optimizing the energy requirement of flow measuring devices, different methods of control can be applied. Thus, there are, for example, battery driven magneto-inductive flow measuring devices, whose efficient use and whose run time essentially depend on control of the energy budget for the energy stored by the batteries. An energy optimized operation of magneto-inductive flow measuring devices can, however, also lead to considerable cost savings in the case of devices, which are supplied with energy by a power supply network, since such devices are, in most cases, in operation for a number of years or decades.

Additionally, measurement disturbances can arise in pipelines, disturbances caused, for instance, by air bubbles, impurities, solids or vortices. Such measurement disturbances influence the flow measurement.

Starting from the aforementioned, posed problem, an object of the present invention is to provide a flow measuring device, which compensates such measurement disturbances and/or can be operated with lessened use of energy.

The present invention achieves this object by a magneto-inductive flow measuring device as defined in claim 1.

A flow measuring device of the invention includes a sensor unit and a measuring- and/or evaluation unit for ascertaining a volume flow, a mass flow and/or a flow velocity of a measured medium in a pipe or tube, characterized in that the flow measuring device has
a) the sensor unit, which is arranged on or in the pipe or tube, for ascertaining the volume flow, the mass flow and/or the flow velocity of the measured medium, and
b) a microphone, which is arranged on or in the pipe or tube.

By means of the microphone, the cumulative energy requirement, thus the time period, in which a provided energy amount is consumed, can be controlled.

Alternatively, or additionally, also a diagnosis of a state change of the measured medium can occur. State changes in the sense of the present invention include, especially, a flow profile change, e.g. due to vortices, and/or a change of the composition of the medium, e.g. a change of the content of solids in the medium, a change in the case of air bubbles in a liquid medium or a change of the viscosity of the medium. A mere change of the volume- or mass flow or the flow velocity is not a state change in the sense the present invention.

The present invention can be applied both in the case of gaseous as well as also in the case of liquid media, wherein the application in the case of liquid media is preferred.

Advantageous embodiments of the invention are subject matter of the dependent claims.

The measuring can occur with a microphone, respectively a measuring microphone capsule, wherein a lower frequency range, down to which the microphone registers measured values, is greater than 2.5 Hz and/or an upper frequency range, up to which the microphone registers measured values is less than 130 kHz. The measuring occurs especially preferably in frequency ranges of less than 20 kHz.

The measuring range lies preferably above 10 dB(A) and/or below 250 dB(A).

The sensitivity of the microphone in the case of the measuring lies preferably in a range of 1 mV/Pa to 50 mV/Pa, especially preferably in a range of 3 mV/Pa to 8 mV/Pa.

The microphone can advantageously transmit at least one acoustic signal, especially a frequency spectrum, via a signal line to the measuring- and/or evaluation unit. This signal line can be embodied as a cable or as a wireless connection. The electrical current supply can occur in the second case, for example, via the sensor element for flow measurement.

A method of the invention for operating a flow measuring device according to claim 1 includes at least one operating mode for an energy-saving operation of the flow measuring device with at least two submodes, respectively two manners of operation, wherein
i) in a first of the at least two submodes the ascertaining of the volume flow, the mass flow and/or the flow velocity of a measured medium occurs with a first sampling rate,
ii) in a second of the at least two submodes the ascertaining of the volume flow, the mass flow and/or the flow velocity of a measured medium occurs with a second sampling rate,
   wherein the second sampling rate is lower than the first sampling rate, characterized in that a switching from the second to the first submode occurs based on an acoustic signal registered by the microphone.

The acoustic signal registered for the control need not absolutely include the entire frequency spectrum. It can also be composed significantly simpler. The microphone is applied in this application as a control unit. The processing of the acoustic signal can occur by comparison with a desired value or a reference spectrum. This comparison can be performed by the measuring- and evaluation unit.

Advantageous embodiments of the method of the invention are subject matter of the dependent claims.

The second sampling rate can also be zero. To the extent that this is the case, the evaluating electronics is operated only with a minimum energy, while the sensor unit is not supplied with energy. This is, thus, a sleep- or stand-by mode.

At least the switching from the “sleep mode”, thus the second submode, into the “normal mode”, thus the first submode, occurs based on the ascertained acoustic signal.

In the “normal mode”, the measuring- and evaluation unit can by comparing the flow values ascertained by the sensor unit also determine, whether the flow velocity is sufficiently constant, in order to switch into the sleep mode. Alternatively, however, also this control can occur via the acoustic signal of the microphone.

The method of the invention enables an energy saving manner of operation both in the case of flow measuring devices, which are operated by an energy supply network, as well as also especially preferably in the case of energy autarkic, especially battery operated, flow measuring devices.

According to the invention, a microphone is used for control of the energy requirement, especially of the cumulative energy requirement, of a flow measuring device.

A method of the invention for operating a flow measuring device according to claim 1, includes at least one operating mode for detection of state changes of a measured medium during, before or after ascertaining the volume flow, the mass flow and/or the flow velocity and is characterized by steps as follows:
i) registering an acoustic frequency spectrum by the microphone;
ii) comparing this registered frequency spectrum with a reference spectrum; and
iii) outputting a state report with reference to the volume flow-, mass flow- and/or flow velocity ascertainment, when the registered frequency spectrum deviates from a characteristic of the reference spectrum.

State changes can often lead to measurement errors. Therefore, it is advantageous, when in the case of an ascertained flow also supplementally a user is told of a state change. Then a better estimate of the reliability of the measured values can be made.

Especially preferably, a quantifying of the deviation of the registered frequency spectrum from the characteristic of the reference spectrum can occur along with ascertaining a correction factor and a correction of the volume flow, the mass flow and/or the flow velocity taking the correction factor into consideration. Thus, a more accurate measured value of flow is obtained.

A microphone is used according to the invention in a flow measuring device for ascertaining state change, especially a measurement disturbance.

Additionally or alternatively, a microphone can be used for quantifying a state change, especially a measurement disturbance, and for compensating an ascertained volume flow, mass flow and/or flow velocity of a measured medium based on the preceding quantifying.

The invention will now be explained in greater detail based on the appended drawing based on an example of an embodiment. The figures of the drawing show as follows:

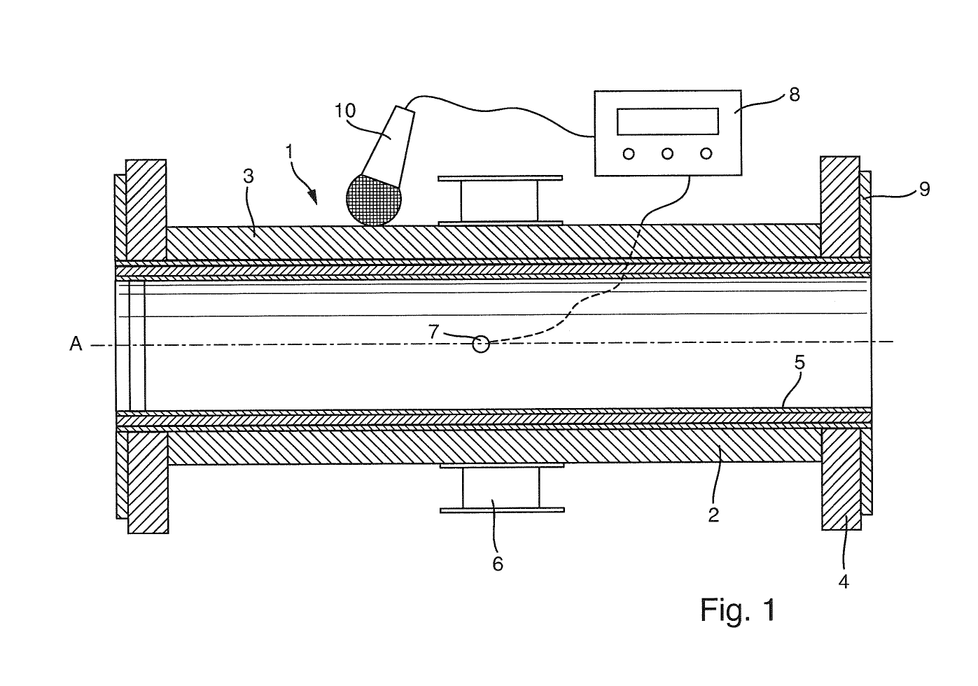

FIG. 1 schematic, sectional view of a flow measuring device of the invention embodied as a magneto-inductive flow measuring device; and

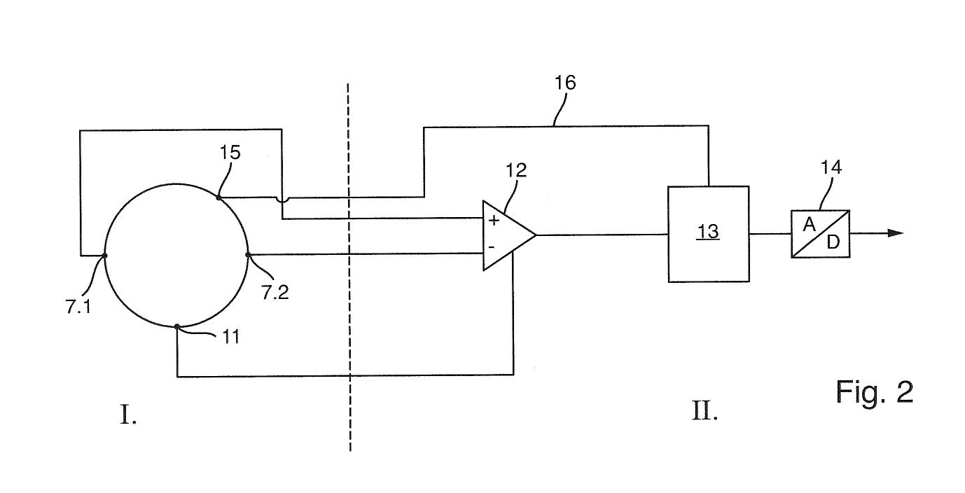

FIG. 2 simplified circuit diagram of the flow measuring device of the invention.

The present invention can be applied to any type of flow measuring device. Corresponding flow measuring devices include, for example, Coriolis flow measuring devices, ultrasonic, flow measuring devices, thermal, flow measuring devices, vortex flow measuring devices, magneto-inductive flow measuring devices, SAW (surface acoustic wave) flow measuring devices, V-cone flow measuring devices and suspended body flow measuring devices. The following example of an embodiment describes the application of the present invention in a magneto-inductive flow measuring device. It is, however, understood that the invention can also be advantageously applied in the case of another type of flow measuring device.

The terminology, flow measuring device, in the sense the present invention, includes also arrangements, such as e.g. ultrasonic, clamp-on arrangements, in the case of which no measuring tube is present, but, instead, the sensors are mounted directly on a process pipe or tube.

The flow measuring device is preferably applied for process automation.

The construction and the measuring principle of a magneto-inductive flow measuring device are basically known. According to Faraday's law of induction, a voltage is induced in a conductor moving in a magnetic field. In the case of the magneto-inductive measuring principle, flowing measured material corresponds to the moved conductor. A magnetic field of constant strength is produced by a magnet system. The magnet system can preferably be two field coils, which be arranged diametrally opposite one another on the measuring tube at equal positions along the axis of the measuring tube.

Located perpendicularly thereto on the tube inner wall of the measuring tube are two or more measuring electrodes, which sense the voltage produced in the case of flow of the measured substance through the measuring tube. The induced voltage is proportional to the flow velocity and therewith to the volume flow. The magnetic field produced by the field coils is the result of a clocked, direct current of alternating polarity. This assures a stable zero-point and makes the measuring insensitive to influences of multiphase materials, inhomogeneities in the liquid or low conductivity. Known are magneto-inductive flow measuring devices with coil arrangements having more than two field coils and other geometrical arrangements. The applicant has been selling magneto-inductive flow measuring devices in different dimensions and embodiments, for example, under the mark “Promag”, for a number of decades.

The above-described flow measuring device represents one of the most common constructions. In the case of clamp-on measuring devices (e.g. in the case of ultrasonic, flow measuring devices), there is no measuring tube, but, instead, a pipeline of a process system. A pipe or tube in the sense the invention can, thus, be both a pipeline, e.g. a pipeline in a plant, as well as also a measuring tube. Moreover, also known are magneto-inductive flow measuring devices with more than two field coils and more than two measuring electrodes.

FIG. 1 shows a flow measuring device 1 embodied as a magneto-inductive flow measuring device with a measuring tube 2, which has a measuring tube axis A. Measuring tube 2 is usually of metal and includes as protection a plastic lining, the so-called liner 3. Flanges 4 terminate the measuring tube 2. The liner can, in such case, extend over the connection surfaces 9 of the flanges 4. In a typical construction, a magnet system 6 composed of two or more field coils is arranged on the measuring tube. Positioned offset by 90° diametrally oppositely on the measuring tube 2 are additionally two measuring electrodes 7. These sense the measurement voltage as a function of the flow.

Via a signal line, cable or wireless, the measurement voltage is transmitted to a measuring- and evaluation unit 8.

A further component of the flow measuring device is a microphone 10, which is arranged on the or in the measuring tube 2. The microphone can especially preferably be arranged on the surface of the measuring tube.

It can, however, also partially contact the medium. The latter variant is, however, less preferable, since such a measuring point must be sealed. Additionally, the parts of the microphone 10 contacting the medium 5 must be resistant to the medium.

The invention rests on the fact that flow changes can be detected via the acoustic frequency spectrum. Flow changes can be detected via the measured frequency spectrum.

A simplified circuit of the flow measuring device of FIG. 1 is shown in FIG. 2. The left region I shows in simplified manner the circuitry in the region of the measuring tube. In addition to measuring electrodes 7.1 and 7.2, the measuring tube includes a grounding electrode 11. The signals of these three electrodes are fed in the measuring- and evaluation unit in the right region II to a measurement amplifier 12, is which amplifies the signals and forwards them to a multiplexer 13. Then, the A/D occurs, i.e. conversion of the signals by means of an ND converter 14, followed by forwarding to a computing unit (not shown), which processes and outputs the signals.

In addition to the signals of the measuring electrodes 7.1, 7.2 and the grounding electrode 11, also the signal of the microphone 15 is fed to the multiplexer 13, this signal by means of a dedicated signal line 16.

A flow measuring device equipped with a microphone enables operation in two or more operating modes, which were previously implemented in other manner and which will now be explained in detail. In such case, only one of the two operating modes can be implemented on the respective flow measuring device or a number of operating modes.

The first operating mode is an energy saving mode. Usually, a flow measuring device has different scanning rates available. The flow measuring device includes at least one sensor unit and a control element.

For flow measuring devices, especially magneto inductive flow measuring devices, preferably flow measuring devices driven with limited energy supply, such as e.g. battery power, usually different measurement modes are offered, which represent a trade-off between high sampling rate and high battery service life. Each measured value registration requires energy for producing the magnetic field and the measured value processing. If the sampling rate is high (e.g. 10 SAPs (samples per second)), flow changes are rapidly recognized, and energy consumption is increased. In the case of very low scanning rates (e.g. 0.05 SAPs), the energy consumption is clearly smaller, and the measuring device reacts more slowly to flow changes, whereby a larger measurement error arises.

It is, consequently, desirable to implement a measuring mode, which varies the sampling rate as a function of the flow profile. In the case of flow changes, sampling/measuring is frequent and in the case of constant flows seldom.

A sensor unit can be e.g. the ultrasonic transducer of an ultrasonic, flow measuring device or, however, the totality of magnet system and measuring electrodes in a magneto-inductive flow measuring device. In the case of other measuring principles, the sensor unit is the totality of elements, which a flow measuring device requires, in order to obtain a flow referenced measurement signal. That means there are both elements, which are required for excitation as well as also elements for detection of a measurement signal.

The concept, sampling rate, means in the sense of the present invention that between each ascertaining of a measured value a measuring pause occurs.

The sampling rate gives how many measured values, or measurement points, are ascertained within a predetermined time interval.

In the energy saving mode, the measuring device has at least two submodes.

A first submode designates a normal measuring mode, in which the sensor unit is operated. In the normal measuring mode, the flow measurement occurs with a first sampling rate. The height of the sampling rate is a function of the respective measuring principle. In the case of ultrasonic, flow measurement, it is a function of the separation between two so-called ultrasonic bursts. In the case of magneto-inductive flow measurement, it is a function of the points in time between two poling changes.

A second submode designates a mode in which the sensor unit is operated with little energy consumption. In this case, the flow measurement occurs with a second sampling rate. This second sampling rate is, in such case, low, preferably at least 4-times lower than the first sampling rate.

This means that there are less measurement points ascertained in a time interval. At the same time, also less energy is required, since a flow measurement always requires excitation energy and always energy for obtaining the computing power for evaluation of the measurement signals. This energy can be saved in the second submode by accepting the disadvantage of a worse measuring performance. This submode is especially suitable for flow measurement in the case of relatively constant flows.

In the second submode, an option is to supply only the electronics of the measuring- and evaluation unit with energy, so that no active flow measurement occurs.

In the case of a flow with rapidly changing flow rates, no exact balancing of the flow is achieved from individual measured values, since too few measurement points are registered. Here, the flow measurement should occur in the first submode, the normal measuring mode.

The microphone 10, 15 serves in this operating mode as control unit for switching at least from the mode with little energy consumption into the normal measuring mode. A flow change or a number of flow changes can be ascertained by comparing a currently-ascertained frequency spectrum with a previously-ascertained frequency spectrum.

To the extent that the measuring- and evaluation unit ascertains in the comparing of the currently ascertained frequency spectrum a significant deviation from the preceding frequency spectrum, then the measuring- and evaluation unit switches the flow measuring device from the second submode into the first submode.

To the extent that the measuring- and evaluation unit ascertains in the comparing of the currently ascertained frequency spectrum with a number of preceding frequency spectra no significant deviation, then the measuring- and evaluation unit switches the flow measuring device from the first into the second submode.

Alternatively, the measuring- and evaluation unit can perform a comparing of the ascertained flow measured values with a number of preceding flow measured values. To the extent that no significant deviation between the flow measured values was ascertained, then the measuring- and evaluation unit switches the flow measuring device from the first into the second submode. In this case, not the frequency spectra of the microphone, but, instead, the flow measured values ascertained in the normal mode serve as decision criterion, whether a switching into the mode with little energy consumption should occur.

The second operating mode, which can be implemented with the assistance of the microphone, serves for diagnosis of the flowing measured medium. In this diagnostic mode, the microphone ascertains, whether, due to the frequency spectrum, flow disturbances, especially flow vortices, particles and/or air bubbles, are present in the measured medium. If this is the case, then an indication can occur that the flow is disturbed.

In a further developed embodiment of this second operating mode, comparison of the ascertained frequency spectrum with different reference spectra furnished in a database ascertains the type of flow disturbance. The reference spectra are furnished for different measured media. Air bubbles in water have e.g. another acoustic reference spectrum than particles.

It is even possible via the quantifying of individual frequencies to ascertain a trend concerning the scope of the flow disturbance and to take this trend into consideration in the form of a correction value for the ascertained flow.

Thus, through use of a microphone 15 in a flow measuring device, a flow profile can be registered, with which flow ascertained by the sensor unit can be evaluated and in a preferred variant even corrected.

The two operating modes, thus the energy saving mode and the diagnostic mode, can be implemented in a flow measuring device individually or in combination.

The example of an embodiment of FIG. 1 shows a metal measuring tube 2. However, also a plastic tube can be applied, instead of a metal tube with liner. The corresponding measuring tube fulfills additionally the requirements of diffusion density, mechanical strength and electrical insulation needed for the measuring principle, so that a directly ready plastic measuring tube has no disadvantages compared with other conventional measuring tubes for flow measuring devices.

### REFERENCE CHARACTERS

1 flow measuring device
2 pipe, especially measuring tube
3 liner
4 flange
5 measured medium
6 magnet system
7 measuring electrode
8 measuring- and evaluation unit
9 connection surface
10 microphone
11 grounding electrode (ground)
12 measurement amplifier
13 multiplexer
14 analog/digital converter
15 microphone
16 signal line
A measuring tube axis
I first region (sensor- and control unit)
II second region (transmitter, respectively measuring- and evaluation unit)

1. Flow measuring device (1) comprising a sensor unit and a measuring- and/or evaluation unit (8) for ascertaining a volume flow, a mass flow and/or a flow velocity of a measured medium (5) in a pipe or tube (2), characterized in that the flow measuring device (1) has
a) the sensor unit, which is arranged on or in the pipe or tube (2), for ascertaining the volume flow, the mass flow and/or the flow velocity of the measured medium, and
b) a microphone (10, 15), which is arranged on or in the pipe or tube (2).

2. Flow measuring device as claimed in claim 1, characterized in that a lower frequency range, down to which the microphone registers measured values, is greater than 2.5 Hz and/or an upper frequency range, up to which the microphone registers measured values, is less than 130 Hz.

3. Flow measuring device as claimed in claim 1, characterized in that the microphone (10, 15) transmits at least one acoustic signal, especially a frequency spectrum, via a signal line (16) to the measuring- and/or evaluation unit (8).

4. Method for operating a flow measuring device (1) as claimed in claim 1, comprising at least one operating mode for energy-saving operation of the flow measuring device (1) with at least two submodes, wherein
i) in a first of the at least two submodes the ascertaining of the volume flow, the mass flow and/or the flow velocity of a measured medium occurs with a first sampling rate,
ii) in a second of the at least two submodes the ascertaining of the volume flow, the mass flow and/or the flow velocity of a measured medium occurs with a second sampling rate, wherein the second sampling rate is lower than the first sampling rate, characterized in that
a switching from the second to the first submode occurs based on an acoustic signal registered by the microphone (10, 15).

5. Method as claimed in claim 4, characterized in that the second sampling rate is zero.

6. Method as claimed in claim 4, characterized in that the switching from the second to the first submode occurs by comparing the registered acoustic signal with a reference signal and the switching of the operation submodes occurs when the acoustic signal deviates from a characteristic of the reference signal.

7. Use of a microphone (10, 15) for controlling an energy requirement, especially a cumulative energy requirement, of a flow measuring device (1).

8. Method for operating a flow measuring device (1) as claimed in claim 1, comprising at least one operating mode for detection of state changes of a measured medium (5) during, before or after ascertaining the volume flow, the mass flow and/or the flow velocity of a measured medium (5) in a pipe or tube (2), characterized by steps as follows:
i) registering an acoustic frequency spectrum by the microphone (10, 15);
ii) comparing this registered frequency spectrum with a reference spectrum; and
iii) outputting a state report with reference to the volume flow-, mass flow- and/or flow velocity ascertainment, when the registered frequency spectrum deviates from a characteristic of the reference spectrum.

9. Method as claimed in claim 8, characterized in that a quantifying of the deviation of the registered frequency spectrum from the characteristic of the reference spectrum occurs along with ascertaining a correction factor and a correction of the volume flow, the mass flow and/or the flow velocity taking the correction factor into consideration.

10. Use of a microphone (10, 15) in a flow measuring device (1) for ascertaining state change, especially a measurement disturbance of a measured medium (5) in a pipe or tube (2).

11. Use of a microphone (10, 15) for quantifying state change, especially a measurement disturbance, and for compensating an ascertained volume flow, mass flow and/or flow velocity of a measured medium (5) in a pipe or tube (2).
